(19) United States
(12) Patent Application Publication
(10) Pub. No.: US 2025/0056432 A1
(43) Pub. Date: Feb. 13, 2025

(54) SYSTEMS AND METHODS FOR POWER CONTROL FOR SIDELINK WAVEFORMS

(71) Applicant: QUALCOMM Incorporated, San Diego, CA (US)

(72) Inventors: Chih-Hao LIU, San Diego, CA (US); Xiaoxia ZHANG, San Diego, CA (US); Giovanni CHISCI, San Diego, CA (US); Jing SUN, San Diego, CA (US)

(21) Appl. No.: 18/446,695

(22) Filed: Aug. 9, 2023

(51) Int. Cl. H04W 52/50; H04L 5/00; H04W 72/232

(52) U.S. Cl. CPC H04W 52/50; H04L 5/0055; H04W 72/232

(57) ABSTRACT

Wireless communications systems and methods related to sidelink communication between user equipments (UEs). A first UE determines a power level for a physical sidelink format indicator channel (PSFCH) with multiple interlaced resource blocks (RBs) and/or a common interlace. If a reference power level is provided by a network device such as a base station, the UE may determine power levels based on the reference power level. The UE may also determine power levels based on maximum supported power levels for the UE. In some embodiments, a common interlace uses a fixed percentage of maximum UE power. In other embodiments, available transmit power is evenly split between PSFCH RBs and a common interlace. Priority PSFCH dropping rules may be implemented when scheduled PSFCHs exceed power limitations.

### TECHNICAL FIELD

This application relates to wireless communication systems, and more particularly to improving sidelink communication with New Radio (NR) devices.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

Sidelink was introduced to allow a UE to send data to another UE without tunneling through the BS and/or an associated core network. Sidelink technology has been extended to provision for device-to-device (D2D) communications, vehicle-to-everything (V2X) communications, and/or cellular vehicle-to-everything (C-V2X) communications. Similarly, NR may be extended to support sidelink communications for D2D, V2X, and/or C-V2X over a dedicated spectrum, a licensed spectrum, and/or an unlicensed spectrum.

In existing systems, sidelink communications may include physical sidelink feedback channel (PSFCH) communications between UEs. These communications may be performed with each message comprising a single resource block over a single symbol period. Transmit power for these PSFCH messages may be determined by the UEs according to predetermined rules. Existing methods, however, do not account for additional waveform types. Therefore, there is a need for improved methods of power control for sidelink waveforms.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a first user equipment (UE). The method comprises computing a total common interlace transmit power based on a predetermined percentage of a maximum transmit power capability of the first UE. The method further comprises. The method further comprises computing a total physical sidelink feedback channel (PSFCH) transmit power for a quantity of PSFCH resource blocks (RBs), wherein the computing the total PSFCH transmit power for the quantity of PSFCH RBs comprises at least one of: computing, when the first UE has received a PSFCH power requirement from a network device, the total PSFCH transmit power for the quantity of PSFCH RBs based on the PSFCH power requirement, the quantity of PSFCH RBs, and a pathloss measurement between the first UE and the network device; or computing, when the first UE has not received a PSFCH power requirement from the network device, the total PSFCH transmit power for the quantity of PSFCH RBs based on the maximum transmit power capability of the first UE, the total common interlace transmit power, and the quantity of PSFCH RBs. The method further comprises transmitting a signal to a second UE including the PSFCH RBs at the total PSFCH transmit power.

In another aspect of the disclosure, a method of wireless communication performed by a first user equipment (UE). The method comprises computing a total physical sidelink feedback channel (PSFCH) transmit power for a quantity of PSFCH resource blocks (RBs), wherein the computing the total PSFCH transmit power for the quantity of PSFCH RBs comprises at least one of: computing, when the first UE has received a PSFCH power requirement from a network device, the total PSFCH transmit power for the quantity of PSFCH RBs based on the PSFCH power requirement, the quantity of PSFCH RBs, a quantity of common interlace RBs, and a pathloss measurement between the first UE and the network device; or computing, when the first UE has not received a PSFCH power requirement from the network device, the total PSFCH transmit power for the quantity of PSFCH RBs based on a maximum transmit power capability of the first UE, the quantity of PSFCH RBs, and the quantity of common interlace RBs. The method further comprises transmitting a signal to a second UE including the PSFCH RBs at the total PSFCH transmit power.

In another aspect of the disclosure, a first user equipment (UE), comprising at least one memory, at least one transceiver, and at least one processor in communication with the at least one memory and the at least one transceiver. The first UE is configured to compute a total common interlace transmit power based on a predetermined percentage of a maximum transmit power capability of the first UE. The first UE is further configured to compute a total physical sidelink feedback channel (PSFCH) transmit power for a quantity of PSFCH resource blocks (RBs), wherein the computing the total PSFCH transmit power for the quantity of PSFCH RBs comprises at least one of: computing, when the first UE has received a PSFCH power requirement from a network device, the total PSFCH transmit power for the quantity of PSFCH RBs based on the PSFCH power requirement, the quantity of PSFCH RBs, and a pathloss measurement between the first UE and the network device; or computing, when the first UE has not received a PSFCH power requirement from the network device, the total PSFCH transmit power for the quantity of PSFCH RBs based on the maximum transmit power capability of the first UE, the total common interlace transmit power, and the quantity of PSFCH RBs. The first UE is further configured to transmit a signal to a second UE including the PSFCH RBs at the total PSFCH transmit power.

In another aspect of the disclosure, a first user equipment (UE), comprising at least one memory, at least one transceiver, and at least one processor in communication with the at least one memory and the at least one transceiver. The first UE is configured to compute a total physical sidelink feedback channel (PSFCH) transmit power for a quantity of PSFCH resource blocks (RBs), wherein the computing the total PSFCH transmit power for the quantity of PSFCH RBs comprises at least one of: computing, when the first UE has received a PSFCH power requirement from a network device, the total PSFCH transmit power for the quantity of PSFCH RBs based on the PSFCH power requirement, the quantity of PSFCH RBs, a quantity of common interlace RBs, and a pathloss measurement between the first UE and the network device; or computing, when the first UE has not received a PSFCH power requirement from the network device, the total PSFCH transmit power for the quantity of PSFCH RBs based on a maximum transmit power capability of the first UE, the quantity of PSFCH RBs, and the quantity of common interlace RBs. The first UE is further configured to transmit a signal to a second UE including the PSFCH RBs at the total PSFCH transmit power.

Other aspects, features, and embodiments of the present invention will become apparent to those of ordinary skill in the art upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a wireless communication network that provisions for sidelink communications according to some aspects of the present disclosure.

FIG. 3 illustrates a sidelink communication scheme according to some aspects of the present disclosure.

FIG. 4 is a block diagram of an exemplary user equipment (UE) according to some aspects of the present disclosure.

FIG. 5A is a flow diagram of a method of sidelink communication according to some aspects of the present disclosure.

FIG. 5B is a flow diagram of a method of sidelink communication according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5* Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 400 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Sidelink communications refers to the communications among user equipment devices (UEs) without tunneling through a base station (BS) and/or a core network (e.g., via a PC5 link instead). Sidelink communication can be communicated over a physical sidelink control channel (PSCCH), a physical sidelink shared channel (PSSCH), a physical sidelink feedback channel (PSFCH), etc. The PSCCH is analogous to a physical downlink control channel (PDCCH) and the PSSCH to a physical downlink shared channel (PDSCH) in downlink (DL) communication between a BS and a UE.

As used herein, the term “sidelink UE” can refer to a user equipment device performing a device-to-device communication or other types of communications with another user equipment device independent of any tunneling through the BS (e.g., gNB) and/or an associated core network. As used herein, the terms “sidelink transmitting UE” and “transmitting UE” can refer to a user equipment device performing a sidelink transmission operation. As used herein, the terms “sidelink receiving UE” and “receiving UE” can refer to a user equipment device performing a sidelink reception operation.

In order to improve bandwidth, and increase flexibility of communications, networks may support additional types of waveforms for existing communication types (e.g., PSFCH communication). UEs may need to determine the transmit power level of such communications with different waveforms so that they are able to communicate reliably, and without interfering excessively with communication between other devices. For example, a PSFCH communication (e.g., a message including an acknowledge/negative acknowledge (ACK/NACK) may be desired to be communicated over multiple resource blocks, over multiple symbol periods. These multiple symbol periods may be interlaced in time with other communications. In order to meet occupied carrier bandwidth requirements, a common interlace may be provided which is transmitted interlaced with PSFCH communications. Transmit power levels may need to be determined by the UE in a way that accounts for these new waveforms.

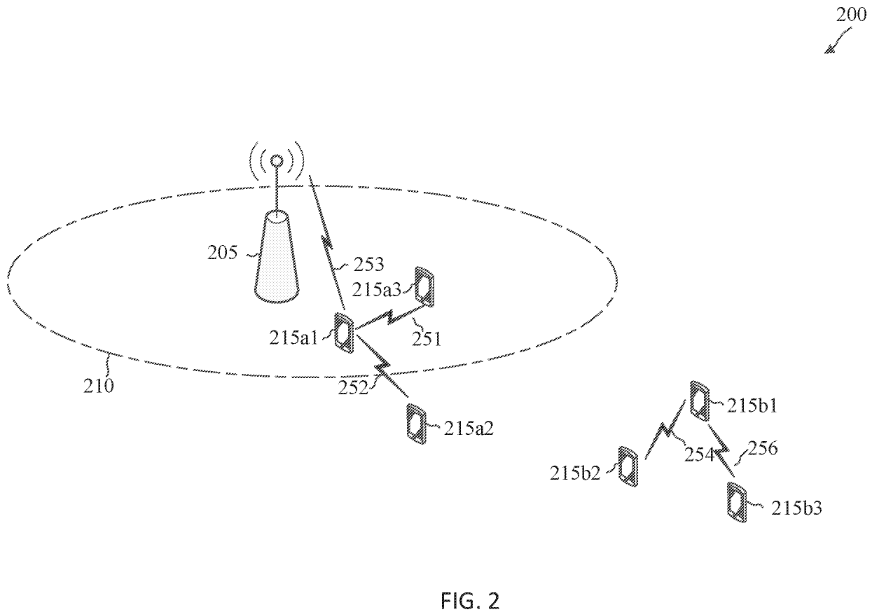

The present application describes mechanisms for the transmission of sidelink communications. One type of PSFCH waveform may be an “interlaced” PSFCH waveform, which occupies 10 resource blocks (RBs). Another may be a “capacity enhanced” PSFCH waveform, which occupies a configured number of RBs, together with a common interlace with a preconfigured number of RBs (generally 10). The parameter which configures the number of RBs used for a capacity enhanced PSFCH waveform may be designated as K3. For both interlaced and capacity enhanced PSFCH waveforms, resource blocks may be in non-contiguous interlaced symbol periods. For example, an interlaced PSFCH waveform may occupy every fifth symbol period for an RB-set. For capacity enhanced PSFCH waveforms, a common interlace may occupy every fifth symbol period for an RB-set, and the PSFCH waveform may occupy all or a subset of symbol periods of a configured offset from the common interlace symbols. An exemplary interlace is illustrated in FIG. 2.

UEs may have certain parameters and/or measurements which may inform the transmit power of PSFCH and/or common interlace communications. For example, a UE may have a maximum transmit power which it supports. Further, a base station or other network device may configure a reference power (e.g., P0) which a UE may use together with a pathloss measurement to determine an allowable transmit power.

If the number of PSFCHs scheduled to be transmitted in an RB-set will cause the UE to exceed an allowable transmit power, the UE may drop PSFCH communications based on a priority order.

Aspects of the present disclosure provide several benefits. For example, Excessive interference of communication signals is avoided by computing transmit power accounting for other network devices. Allowing for interlaced waveforms for PSFCH communication may increase the bandwidth and/or robustness of the communication link. Accounting for PSFCH communications with a configurable number of resource blocks allows for higher network adaptability for varying network conditions. Providing a common interlace using the methods described herein allows the device to meet channel occupancy bandwidth requirements, while staying within provided power budgets.

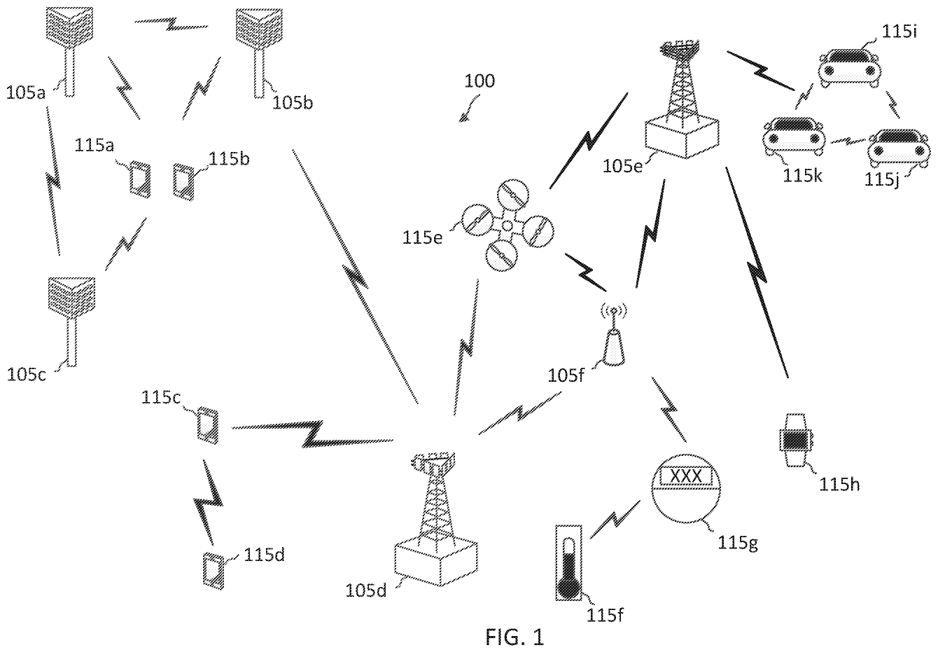

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may more generally be considered a network device. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115 (such as and including according to embodiments of the present disclosure).

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as with small cells, such as the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105 (e.g., PC5 etc.).

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands (i.e., sub-channels). In other instances, the subcarrier spacing (SCS) and/or the duration of TTIs may be scalable.

Both LTE and NR UEs 115 coexist in network 100. In this discussion, NR devices includes devices that are capable of both NR and LTE communication, and generally LTE devices are only capable of LTE communication. LTE generally uses a subcarrier spacing (SCS) of 15 kHz. For NR, SCS is configurable (e.g., either 15 kHz, 30 kHz, or 60 kHz), although typically uses a 30 kHz SCS. OFDM transmission schemes allow for signals of a single SCS to be orthogonal to each other, but with adjacent resources using different SCS values, signals nearby in frequency to each other may cause excessive interference. For example, a sub-channel for LTE communication using a 15 kHz SCS adjacent to an NR sub-channel using a 30 kHz SCS would result in the NR signals interfering with the LTE signals. Especially in circumstances where the power level of the NR signals is higher relative to the LTE signals, the signal to noise ratio may be decreased substantially.

In some aspects, the BSs 105 can assign or schedule transmission resources (e.g., in the form of time-frequency resource elements (RE)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., a PSS and a SSS) in the network 100 to facilitate synchronization. The BSs 105 can broadcast system information associated with the network 100 (e.g., including a master information block (MIB), remaining minimum system information (e.g., RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (e.g., PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT (e.g., a channel occupancy time). For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

In some aspects, the network 100 may support stand-alone sidelink communication among the UEs 115 over a shared radio frequency band. NR supports multiple modes of radio resource allocations (RRA), including a mode-1 RRA and a mode-2 RRA, for sidelink over a licensed spectrum. The mode-1 RRA supports network controlled RRA that can be used for in-coverage sidelink communication. For this mode, there is significant base station involvement and is typically operable when the sidelink UE 115 is within the coverage area of the serving BS 105, but not necessarily for out-of-coverage sidelink scenarios. The mode-2 RRA supports autonomous RRA that can be used for out-of-coverage sidelink UEs 115 or partial-coverage sidelink UEs 115.

Alternatively, a stand-alone system may include a sidelink UE 115 designated as an anchor UE (e.g., an anchor node). The anchor UE 115 may initiate sidelink operations with one or more client UEs 115 autonomously (e.g., independent of any cell and/or associated core network). Accordingly, the anchor UE 115 may announce system parameters (e.g., information associated with a sidelink master information block (SL-MIB), remaining minimum system information (RMSI), primary synchronization signal (PSS), secondary synchronization signal (SSS), and/or the like) for the operation of each of the client UEs 115, and the anchor UE 115 may provide respective radio resource control (RRC) configurations for corresponding client UEs 115. For example, the anchor UE 115 may provide first RRC configurations to a first client UE 115 and different second RRC configurations to a second client UE 115. Moreover, while the anchor UE 115 may interface with the client UEs using mode-1 RRA or mode-2 RRA, the signaling received by the client UEs 115 may remain the same between the two modes.

Sidelink UEs 115 (e.g., UEs 115 and 115d in FIG. 1, and/or UEs 115f and 115g) may perform aspects of methods described herein, including determining transmit power for sidelink communications.

FIG. 2 illustrates an example of a wireless communication network 200 that provisions for sidelink communications according to aspects of the present disclosure. The network 200 may correspond to at least a portion of the network 100. FIG. 2 illustrates a BS 205 and six UEs 215 (shown as 215a1, 215a2, 215a3, 215b1, 215b2, and 215b3) for purposes of simplicity of discussion, though it will be recognized that aspects of the present disclosure may scale to any suitable number of UEs 215 and/or BSs 205. The BS 205 and the UEs 215 may be similar to the BSs 105 and the UEs 115, respectively. The BSs 205 and the UEs 215 may share the same radio frequency band (or at least a sub-band thereof) for communications. In some instances, the radio frequency band may be a 2.4 GHz unlicensed band, a 5 GHz unlicensed band, or a 6 GHz unlicensed band (or some other band, such as FR2). In general, the shared radio frequency band may be at any suitable frequency.

The BS 205 and the UEs 215a1-215a3 may be operated by a first network operating entity. The UEs 215b1-215b3 may be operated by a second network operating entity. In some aspects, the first network operating entity may utilize a same RAT as the second network operating entity. For instance, the BS 205 and the UEs 215a1-215a3 of the first network operating entity and the UEs 215b1-215b3 of the second network operating entity are NR-U devices. In some other aspects, the first network operating entity may utilize a different RAT than the second network operating entity. For instance, the BS 205 and the UEs 215a1-215a3 of the first network operating entity may utilize NR-U technology while the UEs 215b1-215b3 of the second network operating entity may utilize WiFi or LAA technology.

In the network 200, some of the UEs 215a1-215a3 and/or UEs 215b1-215b3 may communicate with each other in peer-to-peer communications. For example, the UE 215a1 may communicate with the UE 215a2 over a sidelink 252, the UE 215a1 may communicate with the UE 215a3 over another sidelink 251, the UE 215b1 may communicate with the UE 215b2 over yet another sidelink 254, and the UE215b1 may communicate with the UE 215b3 over sidelink 256. The sidelinks 251, 252, 254, and 256 may be unicast bidirectional links. Some of the UEs 215 may also communicate with the BS 205 in a UL direction and/or a DL direction via communication links 253. For instance, the UE 215a1 and 215a3 are within a coverage area 210 of the BS 205, and thus may be in communication with the BS 205. The UE 215a2 is outside the coverage area 210, and thus may not be in direct communication with the BS 205. In some instances, the UE 215a1 may operate as a relay for the UE 215a2 to reach the BS 205. As an example, some of the UEs 215 may be associated with vehicles (e.g., similar to the UEs 115i-k) and the communications over the sidelinks 251, 252, 254, and 256 may be C-V2X communications. C-V2X communications may refer to communications between vehicles and any other wireless communication devices in a cellular network. This is exemplary only, as the sidelinks may be between any of a variety of different UE types and communications.

Similar to network 100 of FIG. 1, the network 200 may support sidelink communication among the UEs 215, including one or more modes supported by a BS 205, and/or one or more stand-alone modes that do not require BS 205 support. As part of the sidelink communication, a sidelink UE, such as 215b1 (as just one example), may transmit sidelink messages to another UE 215 according to methods described herein.

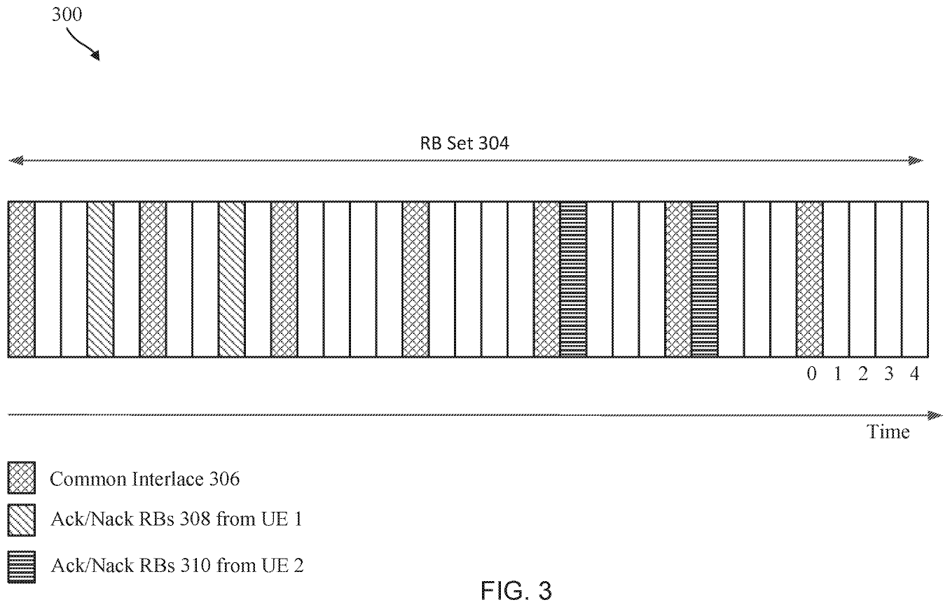

FIG. 3 illustrates a sidelink communication scheme 300 according to some aspects of the present disclosure. The scheme 300 may be employed by UEs such as the UEs 115 and/or 215 in a network such as the networks 100 and/or 200. In particular, sidelink UEs may employ the scheme 300 to engage in sidelink communications over a shared radio frequency band (e.g., in a shared spectrum or an unlicensed spectrum), including PSFCH messaging according to aspects of the present disclosure.

In scheme 300, the x-axis represents time in some arbitrary units. Each illustrated rectangle represents a single RB covering a single symbol period. A group of RBs associated with a transmit occasion may be an RB set 304. The length of the illustrated RB set 304 is exemplary, and RB sets of different lengths may utilize the same methods described herein.

Of the illustrated RBs, those without any hash marks are not utilized in this RB set 304. The other RBs with hash marks are scheduled for transmissions from a UE. For example, common interlace 306 is scheduled for every fifth RB in the RB set. The common interlace symbols may be used as a reference by which other interlaces are indexed. Common interlace 306 may be interlace 0, the RBs immediately after each common interlace 306 RB may be interlace 1, and so on. As illustrated, ACK/NACK carrying RBs 308, which are PSFCH messages, from a first UE may use part of interlace 3, and ACK/NACK carrying RBs 310 from a second UE may use part of interlace 1. In some embodiments, a single UE may transmit on multiple interlaces of an RB set. In cases where a UE is scheduled for 10 RBs for PSFCH, a common interlace 306 may not be needed, and the scheme 300 may exclude common interlace 306.

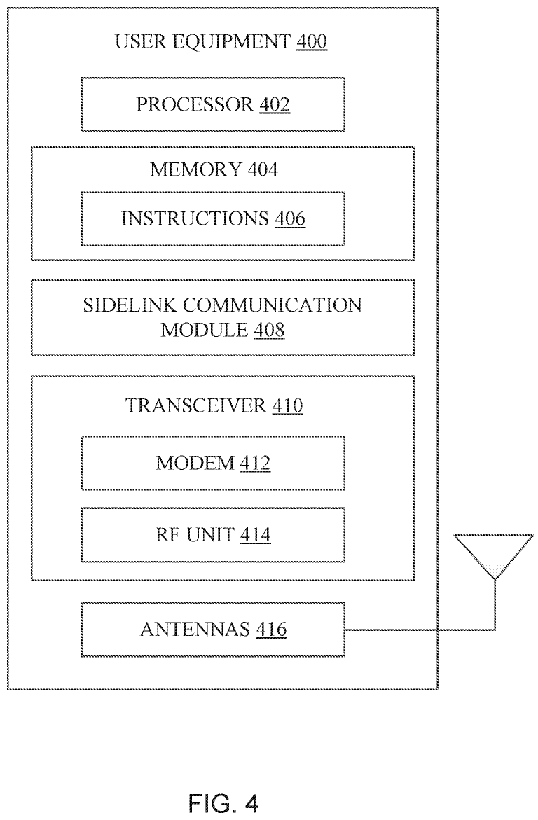

FIG. 4 is a block diagram of an exemplary UE 400 (e.g., a sidelink UE that transmits communications with dropped guard RBs, or a sidelink UE that decodes received communications with dropped guard RBs) according to some aspects of the present disclosure. The UE 400 may be a UE 115 in the network 100 as discussed above in FIG. 1 or a UE 215 discussed above in FIG. 2. As shown, the UE 400 may include a processor 402, a memory 404, a sidelink communication module 408, a transceiver 410 including a modem subsystem 412 and a radio frequency (RF) unit 414, and one or more antennas 416. These elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 404 includes a non-transitory computer-readable medium. The memory 404 may store, or have recorded thereon, instructions 406. The instructions 406 may include instructions that, when executed by the processor 402, cause the processor 402 to perform the operations described herein with reference to the UEs 115 in connection with aspects of the present disclosure, for example, aspects of FIGS. 1-4, and 5A-5B. Instructions 406 may also be referred to as program code. The program code may be for causing a wireless communication device to perform these operations, for example by causing one or more processors (such as processor 402) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink communication module 408 may be implemented via hardware, software, or combinations thereof. For example, the sidelink communication module 408 may be implemented as a processor, circuit, and/or instructions 406 stored in the memory 404 and executed by the processor 402. In some instances, the sidelink communication module 408 can be integrated within the modem subsystem 412. For example, the sidelink communication module 408 can be implemented by a combination of software components (e.g., executed by a DSP or a general processor) and hardware components (e.g., logic gates and circuitry) within the modem subsystem 412.

The sidelink communication module 408 may be used for various aspects of the present disclosure, for example, aspects of FIGS. 1-3 and 5A-5B. Aspects of the sidelink communication module 408 may be used by the UE 400 where the UE 400 is operating in a role where it is transmitting communications with another UE 400, and other aspects of the sidelink communication module 408 may be used by the UE 400 where the UE 400 is operating in a role where it is receiving communication from another UE 400. For example, where the UE 400 is operating in a role where it is receiving communications from another UE 400, the sidelink communication module 408 may cause the UE 400 to receive PSFCH communications with or without a common interlace, at a computed power level.

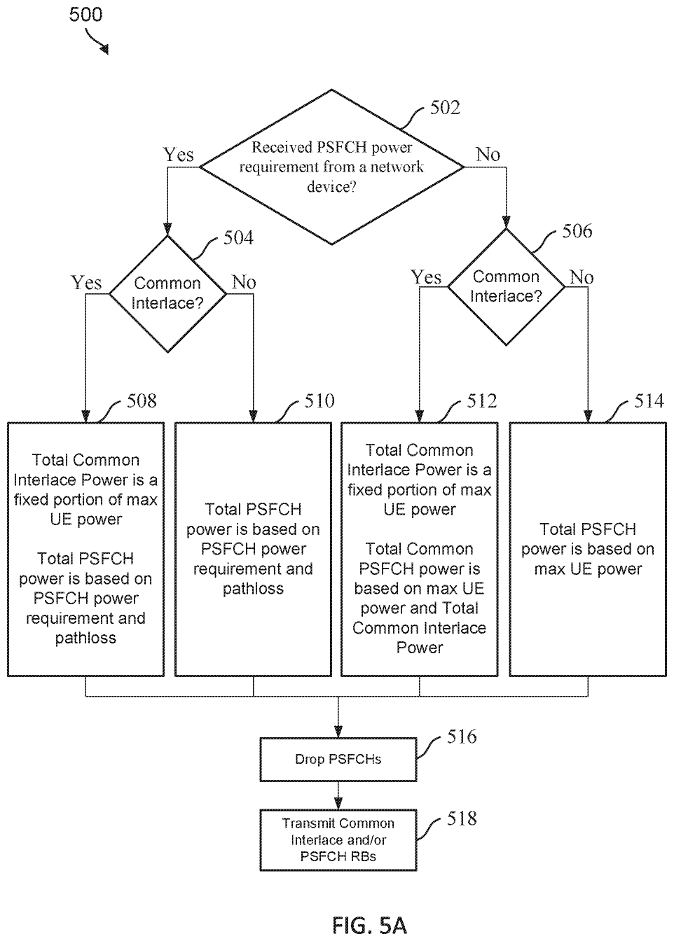

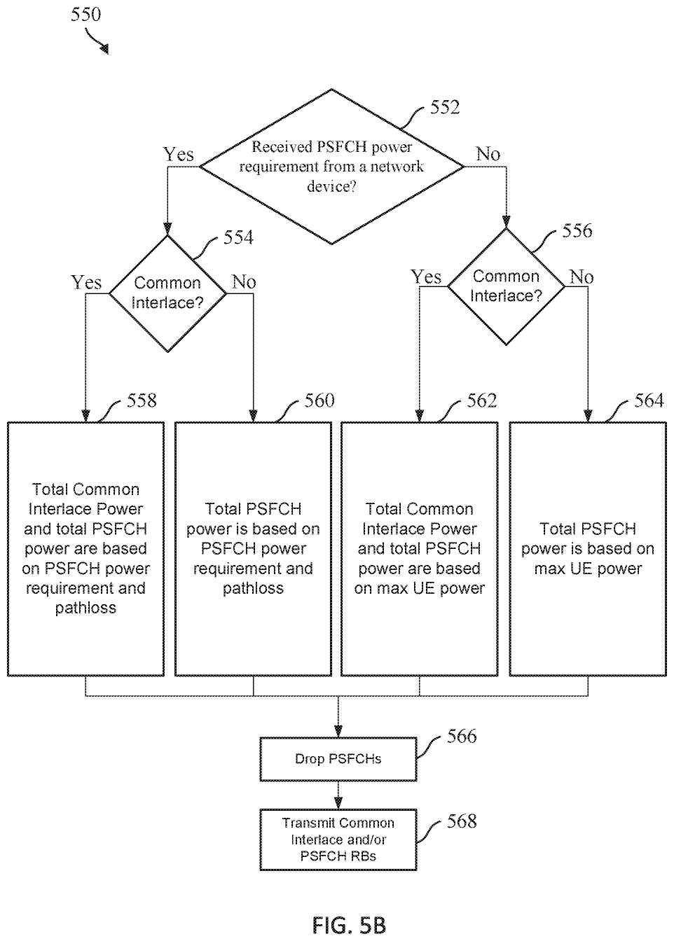

Sidelink communication module 408 may be configured to compute a PSFCH transmission power and/or a common interlace transmission power. Sidelink communication module 408 may compute the transmission powers according to the steps described in FIGS. 5A-5B. Sidelink communication module 408 may be configured to determine PSFCH RBs to drop according to a priority order. Sidelink communication module 408 may further be configured to transmit the PSFCH RBs and common interlace RBs at their respective computed transmission powers.

As shown, the transceiver 410 may include the modem subsystem 412 and the RF unit 414. The transceiver 410 can be configured to communicate bi-directionally with other devices, such as the BSs 105. The modem subsystem 412 may be configured to modulate and/or encode the data from the memory 404 and/or the sidelink communication module 408 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 414 may be configured to process (e.g., perform analog to digital conversion or digital to analog conversion, etc.) modulated/encoded data (e.g., PSFCH data, etc.) from the modem subsystem 412 (on outbound transmissions) or of transmissions originating from another source such as a UE 115 or a BS 105. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 400 to enable the UE 400 to communicate with other devices.

The RF unit 414 may provide the modulated and/or processed data, e.g. data packets (or, more generally, data messages that may contain one or more data packets and other information), to the antennas 416 for transmission to one or more other devices. The RF unit 414 may process the modulated and/or processed data and generate corresponding time-domain waveforms using SC-FDMA modulation prior to transmission via the antennas 416. In other instances, the RF unit 414 may utilize OFDM modulation to generate the time-domain waveforms. The antennas 416 may further receive data messages transmitted from other devices. The antennas 416 may provide the received data messages for processing and/or demodulation at the transceiver 410. The transceiver 410 may provide the demodulated and decoded data (e.g., sidelink configuration, SCI, sidelink data, PSFCH, etc.) to the sidelink communication module 408 for processing. The antennas 416 may include multiple antennas of similar or different designs in order to sustain multiple transmission links. The RF unit 414 may configure the antennas 416. In some aspects, the RF unit 414 may include various RF components, such as local oscillator (LO), analog filters, and/or mixers. The LO and the mixers can be configured based on a certain channel center frequency. The analog filters may be configured to have a certain passband depending on a channel BW. The RF components may be configured to operate at various power modes (e.g., a normal power mode, a low-power mode, power-off mode) and may be switched among the different power modes depending on transmission and/or reception requirements at the UE 400 and/or an anchor UE.

In an aspect, the UE 400 can include multiple transceivers 410 implementing different RATs (e.g., NR and LTE). In an aspect, the UE 400 can include a single transceiver 410 implementing multiple RATs (e.g., NR and LTE). In an aspect, the transceiver 410 can include various components, where different combinations of components can implement different RATs.

FIG. 5A is a flow diagram 500 of a method of sidelink communication according to some aspects of the present disclosure. Aspects of the method 500 can be executed by a computing device (e.g., a processor, processing circuit, and/or other suitable component) of a wireless communication device or other suitable means for performing the steps. For example, between two UEs such as UEs 115a and 115b, UEs 115j and 115k, UEs 215b1 and 215 b2, or 215at and 215a2, or two UE 400s. Aspects of method 500 may utilize one or more components, such as the processor 402, the memory 404, the sidelink communication module 408, the transceiver 410, the modem 412, and the one or more antennas 416, to execute the steps of method 500. As illustrated, the method 500 includes a number of enumerated steps, but aspects of the method 500 may include additional steps before, after, and in between the enumerated steps. In some aspects, one or more of the enumerated steps may be omitted or performed in a different order. The actions performed in flow diagram 500 may be performed with respect to a RB set for PSFCH transmission. For example, a UE may schedule PSFCH transmissions to a second UE using an interlaced RB set.

At decision block 502, a first UE (e.g., UE 400) may determine whether a PSFCH power requirement has been received from a network device (e.g., a BS 105). The PSFCH power requirement may be, for example, a reference power P0 received from a BS 105 via an RRC configuration. This reference power may be used to indicate an allowable power level which may be received at the BS 105. This may prevent excessive interference at the BS 105 from transmissions that are intended to by received by another UE. If a UE is in a coverage range of a BS 105, the BS 105 may configure the UE with a PSFCH power requirement (e.g., reference power). If the UE has received a PSFCH power requirement from a network device, the method continues to decision block 504, otherwise it continues to decision block 506.

At decision block 504, the UE determines if a common interlace is needed. For example, if there are 10 or more PSFCH RBs scheduled for transmission, a common interlace (as described in FIG. 3) may not be needed. If there is a scheduled common interlace, the method proceeds to block 507, otherwise it proceeds to block 510.

At block 508, the UE computes a total common interlace power for the RB set as a fixed portion of a maximum UE power. For example, a preconfigured percentage value alpha may be multiplied by the maximum UE power per RB to determine a per RB power for the common interlace, and this power may be multiplied by the number of RBs in the common interlace (e.g., 10) to compute the total common interlace power. A maximum power for the full interlace may alternatively be multiplied by the preconfigured percentage to determine a common interlace total transmit power, e.g., P_{PSFCH, comm}=α·P_{cmax} where P_{PSFCH, comm} is the total common interlace power for an RB set, α is a preconfigured percentage, and P_{cmax} is a maximum UE transmit power. The total PSFCH power is also computed at block 508 based on the received PSFCH power requirement and a pathloss measurement between the UE and the network device. For example, the total PSFCH power may be computed as

$${P}_{PSFCH , one} = {P}_{O , PSFCH} + 10 {log}_{10} ( {2}^{μ} \cdot {M}_{RB}^{PSFCH} ) + {α}_{PSFCH} \cdot PL [ dB m ]$$

where P_{PSFCH,one} is the total PSFCH power, P_{O, PSFCH} is the received PSFCH power requirement (e.g., reference power P0), μ is a configured value representing the numerology of the communication (e.g., subcarrier spacing), M_{RB}^{PSFCH} is the number of PSFCH RBs, α_{PSFCH} is a preconfigured value, and PL [dBm] is a pathloss measurement between the network device and the UE measured in dBm.

At block 510, the UE may compute a total PSFCH transmit power for the RB set based on the received PSFCH power requirement, and a pathloss measurement between the UE and the network device. This computation may be performed in the same way as the PSFCH power computation at block 508, without a common interlace power calculation as there is no common interlace.

At decision block 506, the UE determines if a common interlace is needed. For example, if there are 10 or more PSFCH RBs scheduled for transmission, a common interlace (as described in FIG. 3) may not be needed. If there is a scheduled common interlace, the method proceeds to block 512, otherwise it proceeds to block 514.

At block 512, the UE computes a total common interlace power for the RB set as a fixed portion of a maximum UE power. For example, a preconfigured percentage value alpha may be multiplied by the maximum UE power per RB to determine a per RB power for the common interlace, and this power may be multiplied by the number of RBs in the common interlace (e.g., 10) to compute the total common interlace power. A maximum power for the full interlace may alternatively be multiplied by the preconfigured percentage to determine a common interlace total transmit power, e.g., P_{PSFCH, comm}=α·P_{cmax} where P_{PSFCH, comm} is the total common interlace power for an RB set, α is a preconfigured percentage, and P_{cmax} is a maximum UE transmit power. The total PSFCH power is also computed at block 512 based on a maximum UE power. In the computation, the maximum UE power may be discounted by the amount of power used for the common interlace. For example, the PSFCH power for each PSFCH transmission may be computed as:

$${P}_{PSFCH , k} ( i ) = 10 {log}_{10} ( {10}^{{P}_{CMAX / 10}} - {10}^{{P}_{PSFCH , comm / 10}} ) - 10 {log}_{10} ( {N}_{Tx , PSFCH} )$$

where P_{PSFCH,k}(i) is the total power per PSFCH transmission including K3 RBs, P_{CMAX} is a maximum UE transmit power, P_{PSFCH,comm} is the computed common interlace power, and N_{Tx,PSFCH} is the number of PSFCH transmissions. The total PSFCH transmit power for the RB set would be this computed power multiplied by the number of PSFCH transmissions.

At block 514, The total PSFCH power is computed based on a maximum UE power similar to block 512, but without discounting for a common interlace. For example, the PSFCH power for each PSFCH transmission may be computed as:

$${P}_{PSFCH , k} ( i ) = 10 {log}_{10} ( {10}^{{P}_{CMAX / 10}} ) - 10 {log}_{10} ( {N}_{Tx , PSFCH} )$$

where P_{PSFCH,k}(i) is the total power per PSFCH transmission including K3 RBs, P_{CMAX} is a maximum UE transmit power, and N_{Tx,PSFCH} is the number of PSFCH RBs in the RB set. The total PSFCH transmit power for the RB set would be this computed power multiplied by the number of PSFCH transmissions.

At block 516, PSFCH RBs are dropped when the amount of power computed in the previous blocks exceeds a maximum allowable power. If the total PSFCH transmit power exceeds the maximum UE transmit power, discounted by any common interlace power, then RBs may be dropped until the power is below the maximum UE transmit power. For example, the UE may drop PSFCH RBs unless:

$${P}_{PSFCH , one , AN} + 10 {log}_{10} ( {N}_{sch , Tx , PSFCH} ) \leq 10 {log}_{10} ( {10}^{{P}_{CMAX / 10}} - {10}^{{P}_{PSFCH , comm / 10}} )$$

where P_{PSFCH,one,AN} is the power of each PSFCH RB RBs in the RB set, N_{Sch,Tx,PSFCH} is the number of PSFCH RBs scheduled for the RB set, P_{CMAX} is a maximum UE transmit power, and P_{PSFCH,comm} is the computed common interlace power. For example, the UE may determine PSFCH transmissions to transmit without dropping first with ascending order of corresponding priority field values over the PSFCH transmissions with HARQ-ACK information, if any, and then with ascending order of priority value over the PSFCH transmissions with conflict information, if any. Any remaining RBs once the selected RBs have reached the maximum allowable power are dropped by the UE.

At block 518, the UE transmits a common interlace (if needed) and/or the scheduled PSFCH RBs to a second UE, each at their respective computed transmit powers.

FIG. 5B is a flow diagram 550 of a method of sidelink communication according to some aspects of the present disclosure. Aspects of the method 550 can be executed by a computing device (e.g., a processor, processing circuit, and/or other suitable component) of a wireless communication device or other suitable means for performing the steps. For example, between two UEs such as UEs 115a and 115b, UEs 115j and 115k, UEs 215b1 and 215 b2, or 215at and 215a2, or two UE 400s. Aspects of method 500 may utilize one or more components, such as the processor 402, the memory 404, the sidelink communication module 408, the transceiver 410, the modem 412, and the one or more antennas 416, to execute the steps of method 550. As illustrated, the method 550 includes a number of enumerated steps, but aspects of the method 550 may include additional steps before, after, and in between the enumerated steps. In some aspects, one or more of the enumerated steps may be omitted or performed in a different order. The actions performed in flow diagram 550 are similar to those in flow diagram 500.

At decision block 552, a first UE (e.g., UE 400) may determine whether a PSFCH power requirement has been received from a network device (e.g., a BS 105). The PSFCH power requirement may be, for example, a reference power P0 received from a BS 105 via an RRC configuration. This reference power may be used to indicate an allowable power level which may be received at the BS 105. This may prevent excessive interference at the BS 105 from transmissions that are intended to by received by another UE. If a UE is in a coverage range of a BS 105, the BS 105 may configure the UE with a PSFCH power requirement (e.g., reference power). If the UE has received a PSFCH power requirement from a network device, the method continues to decision block 554, otherwise it continues to decision block 556.

At decision block 554, the UE determines if a common interlace is needed. For example, if there are 10 or more PSFCH RBs scheduled for transmission, a common interlace (as described in FIG. 3) may not be needed. If there is a scheduled common interlace, the method proceeds to block 557, otherwise it proceeds to block 560.

At block 558, the UE computes a total common interlace power and a total PSFCH transmit power for the RB set based on the PSFCH power requirement and a pathloss measurement between the UE and the network device. For example, the total power allowed based on the PSFCH power requirement may be divided evenly among the common interlace and the PSFCH RBs. the total common interlace transmit power for the RB set may be computed as

$${P}_{O , PSFCH , comm} = {P}_{O , PSFCH} + 10 {log}_{10} ( {2}^{μ} \cdot {M}_{RB}^{PSFCH , comm} ) + {α}_{PSFCH} \cdot PL [ dB m ]$$

where P_{O,PSFCH,comm} is the total common interlace power, P_{O, PSFCH} is the received PSFCH power requirement (e.g., reference power P0), μ is a configured value representing the numerology of the communication (e.g., subcarrier spacing), M_{RB}^{PSFCH,comm} is the number of common interlace RBs, α_{PSFCH} is a preconfigured value, and PL [dBm] is a pathloss measurement between the network device and the UE measured in dBm. The PSFCH power may be computed by the UE as:

$${P}_{O , PSFCH , AN} = {P}_{O , PSFCH} + 10 {log}_{10} ( {2}^{μ} \cdot K 3 ) + {α}_{PSFCH} \cdot PL [ dB m ]$$

where P_{O,PSFCH,AN} is the total PSFCH power, P_{O, PSFCH} is the received PSFCH power requirement (e.g., reference power P0), μ is a configured value representing the numerology of the communication (e.g., subcarrier spacing), K3 is the number of PSFCH RBs, α_{PSFCH} is a preconfigured value, and PL [dBm] is a pathloss measurement between the network device and the UE measured in dBm.

At block 560, the UE may compute a total PSFCH transmit power for the RB set based on the received PSFCH power requirement, and a pathloss measurement between the UE and the network device. This computation may be performed in the same way as the PSFCH power computation at block 558, without a common interlace power calculation as there is no common interlace.

At decision block 556, the UE determines if a common interlace is needed. For example, if there are 10 or more PSFCH RBs scheduled for transmission, a common interlace (as described in FIG. 3) may not be needed. If there is a scheduled common interlace, the method proceeds to block 562, otherwise it proceeds to block 564.

At block 562, the UE computes a total common interlace power and a total PSFCH transmit power for the RB set based on the maximum UE transmit power. For example, the total power allowed maximum UE transmit power requirement may be divided evenly among the common interlace and the PSFCH RBs. The PSFCH power per transmission may be computed by the UE as:

$${P}_{PSFCH , k , AN} ( i ) = {P}_{cmax} - 10 {log}_{10} ( {N}_{TX , PSFCH} \cdot K 3 + {M}_{RB}^{PSFCH , comm} ) + 10 {log}_{10} ( K 3 )$$

where P_{PSFCH,k,AN}(i) is the total power per PSFCH transmission including K3 RBs, P_{cmax} is the maximum UE transmit power, N_{TX,PSFCH} is the number of PSFCH RBs. K3 is a configured value representing the number of PSFCH RBs, and M_{RB}^{PSFCH,comm} is the number of common interlace RBs. The total PSFCH power may be the per RB power multiplied by the number of PSFCH transmissions scheduled.

The total common interlace transmit power for the RB set may be computed as

$${P}_{O , PSFCH , comm} = {P}_{cmax} - 10 {log}_{10} ( {N}_{TX , PSFCH} \cdot K 3 + {M}_{RB}^{PSFCH , comm} ) + 10 {log}_{10} ( {M}_{RB}^{PSFCH , comm} )$$

where P_{O,PSFCH,comm} is the total common interlace power, P_{cmax} is the maximum UE transmit power, N_{TX,PSFCH} is the number of PSFCH transmissions of K3 RBs which will be transmitted, K3 is a configured value representing the number of PSFCH RBs, M_{RB}^{PSFCH,comm} is the number of common interlace RBs. The PSFCH power may be computed by the UE as:

$${P}_{O , PSFCH , AN} = {P}_{O , PSFCH} + 10 {log}_{10} ( {2}^{μ} \cdot K 3 ) + {α}_{PSFCH} \cdot PL [ dB m ]$$

where P_{O,PSFCH,AN} is the total PSFCH power, P_{O, PSFCH} is the received PSFCH power requirement (e.g., reference power P0), μ is a configured value representing the numerology of the communication (e.g., subcarrier spacing), K3 is the number of PSFCH RBs, α_{PSFCH} is a preconfigured value, and PL [dBm] is a pathloss measurement between the network device and the UE measured in dBm.

At block 564, The total PSFCH power is computed based on a maximum UE power similar to block 562, but without discounting for a common interlace. For example, the PSFCH power for each PSFCH transmission may be computed as

$${P}_{PSFCH , k} ( i ) = 10 {log}_{10} ( {10}^{{P}_{CMAX / 10}} ) - 10 {log}_{10} ( {N}_{Tx , PSFCH} )$$

where P_{PSFCH,k}(i) is the total power per PSFCH transmission including K3 RBs, P_{CMAX} is a maximum UE transmit power, and N_{Tx,PSFCH} is the number of PSFCH RBs in the RB set. The total PSFCH transmit power for the RB set would be this computed power multiplied by the number of PSFCH transmissions.

At block 566, PSFCH RBs are dropped when the amount of power computed in the previous blocks exceeds a maximum allowable power. If the total PSFCH transmit power exceeds the maximum UE transmit power, discounted by any common interlace power, then RBs may be dropped until the power is below the maximum UE transmit power. For example, the UE may drop PSFCH RBs unless:

$${P}_{PSFCH , one , AN} + 10 {log}_{10} ( {N}_{sch , Tx , PSFCH} ) \leq 10 {log}_{10} ( {10}^{{P}_{CMAX / 10}} - {10}^{{P}_{PSFCH , comm / 10}} )$$

where P_{PSFCH,one,AN} is the power of each PSFCH RB RBs in the RB set, N_{sch,Tx,PSFCH} is the number of PSFCH RBs scheduled for the RB set, P_{CMAX} is a maximum UE transmit power, and P_{PSFCH,comm} is the computed common interlace power. For example, the UE may determine PSFCH transmissions to transmit without dropping first with ascending order of corresponding priority field values over the PSFCH transmissions with HARQ-ACK information, if any, and then with ascending order of priority value over the PSFCH transmissions with conflict information, if any. Any remaining RBs once the selected RBs have reached the maximum allowable power are dropped by the UE.

At block 568, the UE transmits a common interlace (if needed) and/or the scheduled PSFCH RBs to a second UE, each at their respective computed transmit powers.

Further aspects of the present disclosure include the following:
Aspect 1. A method of wireless communication performed by a first user equipment (UE), the method comprising:
   computing a total common interlace transmit power based on a predetermined percentage of a maximum transmit power capability of the first UE;
   computing a total physical sidelink feedback channel (PSFCH) transmit power for a quantity of PSFCH resource blocks (RBs), wherein the computing the total PSFCH transmit power for the quantity of PSFCH RBs comprises at least one of:
      computing, when the first UE has received a PSFCH power requirement from a network device, the total PSFCH transmit power for the quantity of PSFCH RBs based on the PSFCH power requirement, the quantity of PSFCH RBs, and a pathloss measurement between the first UE and the network device; or
      computing, when the first UE has not received a PSFCH power requirement from the network device, the total PSFCH transmit power for the quantity of PSFCH RBs based on the maximum transmit power capability of the first UE, the total common interlace transmit power, and the quantity of PSFCH RBs; and
   transmitting a signal to a second UE including the PSFCH RBs at the total PSFCH transmit power.
Aspect 2. The method of aspect 1, wherein the transmitting the signal comprises transmitting the signal further including a common interlace at the total common interlace transmit power when the quantity of PSFCH RBs is below a predetermined value.
Aspect 3. The method of aspect 2, wherein the predetermined value is ten.
Aspect 4. The method of any of aspects 1-3, further comprising:
   dropping a subset of the PSFCH RBs when a sum of the total PSFCH transmit power and the total common interlace transmit power exceeds the maximum transmit power capability associated with the first UE.
Aspect 5. The method of aspect 4, wherein the dropping is performed according to a priority order.
Aspect 6. The method of any of aspects 1-5, further comprising:
receiving the PSFCH power requirement from the network device.
Aspect 7. The method of any of aspects 1-6, wherein the PSFCH RBs carry one or more acknowledgement/negative acknowledgement (ACK/NACK) messages.
Aspect 8. A method of wireless communication performed by a first user equipment (UE), the method comprising:
   computing a total physical sidelink feedback channel (PSFCH) transmit power for a quantity of PSFCH resource blocks (RBs), wherein the computing the total PSFCH transmit power for the quantity of PSFCH RBs comprises at least one of:
      computing, when the first UE has received a PSFCH power requirement from a network device, the total PSFCH transmit power for the quantity of PSFCH RBs based on the PSFCH power requirement, the quantity of PSFCH RBs, a quantity of common interlace RBs, and a pathloss measurement between the first UE and the network device; or
      computing, when the first UE has not received a PSFCH power requirement from the network device, the total PSFCH transmit power for the quantity of PSFCH RBs based on a maximum transmit power capability of the first UE, the quantity of PSFCH RBs, and the quantity of common interlace RBs; and
   transmitting a signal to a second UE including the PSFCH RBs at the total PSFCH transmit power.
Aspect 9. The method of aspect 8, further comprising:
   computing a total common interlace transmit power based on the maximum transmit power capability, the quantity of PSFCH RBs, and the quantity of common interlace RBs,
   wherein the transmitting the signal comprises transmitting the signal further including a common interlace at the total common interlace transmit power when the quantity of PSFCH RBs is below a predetermined value.
Aspect 10. The method of aspect 9, wherein the predetermined value is ten.
Aspect 11. The method of any of aspects 9-10, further comprising:
   dropping a subset of the PSFCH RBs when a sum of the total PSFCH transmit power and the total common interlace transmit power exceeds the maximum transmit power capability associated with the first UE.
Aspect 12. The method of aspect 11, wherein the dropping is performed according to a priority order.
Aspect 13. The method of any of aspects 9-12, wherein the total PSFCH transmit power divided by the quantity of PSFCH RBs is equal to the total common interlace transmit power divided by the quantity of common interlace RBs.
Aspect 14. The method of any of aspects 8-13, further comprising:
   receiving the PSFCH power requirement from the network device.
Aspect 15. The method of any of aspects 8-14, wherein the PSFCH RBs carry one or more acknowledgement/negative acknowledgement (ACK/NACK) messages.
Aspect 16. A first user equipment (UE), comprising:
   at least one memory;
   at least one transceiver; and
   at least one processor in communication with the at least one memory and the at least one transceiver, wherein the first UE is configured to:
      compute a total common interlace transmit power based on a predetermined percentage of a maximum transmit power capability of the first UE;
      compute a total physical sidelink feedback channel (PSFCH) transmit power for a quantity of PSFCH resource blocks (RBs), wherein the computing the total PSFCH transmit power for the quantity of PSFCH RBs comprises at least one of:
         computing, when the first UE has received a PSFCH power requirement from a network device, the total PSFCH transmit power for the quantity of PSFCH RBs based on the PSFCH power requirement, the quantity of PSFCH RBs, and a pathloss measurement between the first UE and the network device; or
         computing, when the first UE has not received a PSFCH power requirement from the network device, the total PSFCH transmit power for the quantity of PSFCH RBs based on the maximum transmit power capability of the first UE, the total common interlace transmit power, and the quantity of PSFCH RBs; and
   transmit a signal to a second UE including the PSFCH RBs at the total PSFCH transmit power.
Aspect 17. A first user equipment (UE), comprising:
   at least one memory;
   at least one transceiver; and
   at least one processor in communication with the at least one memory and the at least one transceiver, wherein the first UE is configured to:
      compute a total physical sidelink feedback channel (PSFCH) transmit power for a quantity of PSFCH resource blocks (RBs), wherein the computing the total PSFCH transmit power for the quantity of PSFCH RBs comprises at least one of:
         computing, when the first UE has received a PSFCH power requirement from a network device, the total PSFCH transmit power for the quantity of PSFCH RBs based on the PSFCH power requirement, the quantity of PSFCH RBs, a quantity of common interlace RBs, and a pathloss measurement between the first UE and the network device; or
         computing, when the first UE has not received a PSFCH power requirement from the network device, the total PSFCH transmit power for the quantity of PSFCH RBs based on a maximum transmit power capability of the first UE, the quantity of PSFCH RBs, and the quantity of common interlace RBs; and
   transmit a signal to a second UE including the PSFCH RBs at the total PSFCH transmit power.
Aspect 18. A first user equipment (UE), comprising:
   means for computing a total common interlace transmit power based on a predetermined percentage of a maximum transmit power capability of the first UE;
   means for computing a total physical sidelink feedback channel (PSFCH) transmit power for a quantity of PSFCH resource blocks (RBs), wherein the computing the total PSFCH transmit power for the quantity of PSFCH RBs comprises at least one of:
      computing, when the first UE has received a PSFCH power requirement from a network device, the total PSFCH transmit power for the quantity of PSFCH RBs based on the PSFCH power requirement, the quantity of PSFCH RBs, and a pathloss measurement between the first UE and the network device; or
      computing, when the first UE has not received a PSFCH power requirement from the network device, the total PSFCH transmit power for the quantity of PSFCH RBs based on the maximum transmit power capability of the first UE, the total common interlace transmit power, and the quantity of PSFCH RBs; and
   means for transmitting a signal to a second UE including the PSFCH RBs at the total PSFCH transmit power.
Aspect 19. A first user equipment (UE), comprising:
   means for computing a total physical sidelink feedback channel (PSFCH) transmit power for a quantity of PSFCH resource blocks (RBs), wherein the computing the total PSFCH transmit power for the quantity of PSFCH RBs comprises at least one of:
      computing, when the first UE has received a PSFCH power requirement from a network device, the total PSFCH transmit power for the quantity of PSFCH RBs based on the PSFCH power requirement, the quantity of PSFCH RBs, a quantity of common interlace RBs, and a pathloss measurement between the first UE and the network device; or
      computing, when the first UE has not received a PSFCH power requirement from the network device, the total PSFCH transmit power for the quantity of PSFCH RBs based on a maximum transmit power capability of the first UE, the quantity of PSFCH RBs, and the quantity of common interlace RBs; and
   means for transmitting a signal to a second UE including the PSFCH RBs at the total PSFCH transmit power.
Aspect 20. A non-transitory computer-readable medium having program code recorded thereon for wireless communication by a user equipment, the program code comprising:
   code for causing the user equipment to compute a total common interlace transmit power based on a predetermined percentage of a maximum transmit power capability of the first UE;
   code for causing the user equipment to compute a total physical sidelink feedback channel (PSFCH) transmit power for a quantity of PSFCH resource blocks (RBs), wherein the computing the total PSFCH transmit power for the quantity of PSFCH RBs comprises at least one of:
      computing, when the first UE has received a PSFCH power requirement from a network device, the total PSFCH transmit power for the quantity of PSFCH RBs based on the PSFCH power requirement, the quantity of PSFCH RBs, and a pathloss measurement between the first UE and the network device; or
      computing, when the first UE has not received a PSFCH power requirement from the network device, the total PSFCH transmit power for the quantity of PSFCH RBs based on the maximum transmit power capability of the first UE, the total common interlace transmit power, and the quantity of PSFCH RBs; and
   code for causing the user equipment to transmit a signal to a second UE including the PSFCH RBs at the total PSFCH transmit power.
Aspect 21. A first user equipment (UE), comprising:
   code for causing the user equipment to compute a total physical sidelink feedback channel (PSFCH) transmit power for a quantity of PSFCH resource blocks (RBs), wherein the computing the total PSFCH transmit power for the quantity of PSFCH RBs comprises at least one of:
      computing, when the first UE has received a PSFCH power requirement from a network device, the total PSFCH transmit power for the quantity of PSFCH RBs based on the PSFCH power requirement, the quantity of PSFCH RBs, a quantity of common interlace RBs, and a pathloss measurement between the first UE and the network device; or
      computing, when the first UE has not received a PSFCH power requirement from the network device, the total PSFCH transmit power for the quantity of PSFCH RBs based on a maximum transmit power capability of the first UE, the quantity of PSFCH RBs, and the quantity of common interlace RBs; and
   code for causing the user equipment to transmit a signal to a second UE including the PSFCH RBs at the total PSFCH transmit power.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a first user equipment (UE), the method comprising:
computing a total common interlace transmit power based on a predetermined percentage of a maximum transmit power capability of the first UE;
computing a total physical sidelink feedback channel (PSFCH) transmit power for a quantity of PSFCH resource blocks (RBs), wherein the computing the total PSFCH transmit power for the quantity of PSFCH RBs comprises at least one of:
computing, when the first UE has received a PSFCH power requirement from a network device, the total PSFCH transmit power for the quantity of PSFCH RBs based on the PSFCH power requirement, the quantity of PSFCH RBs, and a pathloss measurement between the first UE and the network device; or
computing, when the first UE has not received a PSFCH power requirement from the network device, the total PSFCH transmit power for the quantity of PSFCH RBs based on the maximum transmit power capability of the first UE, the total common interlace transmit power, and the quantity of PSFCH RBs; and
transmitting a signal to a second UE including the PSFCH RBs at the total PSFCH transmit power.

2. The method of claim 1, wherein the transmitting the signal comprises transmitting the signal further including a common interlace at the total common interlace transmit power when the quantity of PSFCH RBs is below a predetermined value.

3. The method of claim 2, wherein the predetermined value is ten.

4. The method of claim 1, further comprising:
dropping a subset of the PSFCH RBs when a sum of the total PSFCH transmit power and the total common interlace transmit power exceeds the maximum transmit power capability associated with the first UE.

5. The method of claim 4, wherein the dropping is performed according to a priority order.

6. The method of claim 1, further comprising:
receiving the PSFCH power requirement from the network device.

7. The method of claim 1, wherein the PSFCH RBs carry one or more acknowledgement/negative acknowledgement (ACK/NACK) messages.

8. A method of wireless communication performed by a first user equipment (UE), the method comprising:
computing a total physical sidelink feedback channel (PSFCH) transmit power for a quantity of PSFCH resource blocks (RBs), wherein the computing the total PSFCH transmit power for the quantity of PSFCH RBs comprises at least one of:
computing, when the first UE has received a PSFCH power requirement from a network device, the total PSFCH transmit power for the quantity of PSFCH RBs based on the PSFCH power requirement, the quantity of PSFCH RBs, a quantity of common interlace RBs, and a pathloss measurement between the first UE and the network device; or
computing, when the first UE has not received a PSFCH power requirement from the network device, the total PSFCH transmit power for the quantity of PSFCH RBs based on a maximum transmit power capability of the first UE, the quantity of PSFCH RBs, and the quantity of common interlace RBs; and
transmitting a signal to a second UE including the PSFCH RBs at the total PSFCH transmit power.

9. The method of claim 8, further comprising:
computing a total common interlace transmit power based on the maximum transmit power capability, the quantity of PSFCH RBs, and the quantity of common interlace RBs,
wherein the transmitting the signal comprises transmitting the signal further including a common interlace at the total common interlace transmit power when the quantity of PSFCH RBs is below a predetermined value.

10. The method of claim 9, wherein the predetermined value is ten.

11. The method of claim 9, further comprising:
dropping a subset of the PSFCH RBs when a sum of the total PSFCH transmit power and the total common interlace transmit power exceeds the maximum transmit power capability associated with the first UE.

12. The method of claim 11, wherein the dropping is performed according to a priority order.

13. The method of claim 9, wherein the total PSFCH transmit power divided by the quantity of PSFCH RBs is equal to the total common interlace transmit power divided by the quantity of common interlace RBs.

14. The method of claim 8, further comprising:
receiving the PSFCH power requirement from the network device.

15. The method of claim 8, wherein the PSFCH RBs carry one or more acknowledgement/negative acknowledgement (ACK/NACK) messages.

16. A first user equipment (UE), comprising:
at least one memory;
at least one transceiver; and
at least one processor in communication with the at least one memory and the at least one transceiver, wherein the first UE is configured to:
compute a total common interlace transmit power based on a predetermined percentage of a maximum transmit power capability of the first UE;
compute a total physical sidelink feedback channel (PSFCH) transmit power for a quantity of PSFCH resource blocks (RBs), wherein the computing the total PSFCH transmit power for the quantity of PSFCH RBs comprises at least one of:
computing, when the first UE has received a PSFCH power requirement from a network device, the total PSFCH transmit power for the quantity of PSFCH RBs based on the PSFCH power requirement, the quantity of PSFCH RBs, and a pathloss measurement between the first UE and the network device; or
computing, when the first UE has not received a PSFCH power requirement from the network device, the total PSFCH transmit power for the quantity of PSFCH RBs based on the maximum transmit power capability of the first UE, the total common interlace transmit power, and the quantity of PSFCH RBs; and
transmit a signal to a second UE including the PSFCH RBs at the total PSFCH transmit power.

17. The first UE of claim 16, wherein the first UE transmits the signal including a common interlace at the total common interlace transmit power when the quantity of PSFCH RBs is below a predetermined value.

18. The first UE of claim 17, wherein the predetermined value is ten.

19. The first UE of claim 16, wherein the first UE is further configured to:
drop a subset of the PSFCH RBs when a sum of the total PSFCH transmit power and the total common interlace transmit power exceeds the maximum transmit power capability associated with the first UE.

20. The first UE of claim 19, wherein the first UE is further configured to drop the subset of the PSFCH RBs according to a priority order.

21. The first UE of claim 16, wherein the first UE is further configured to receive the PSFCH power requirement from the network device.

22. The first UE of claim 16, wherein the PSFCH RBs carry one or more acknowledgement/negative acknowledgement (ACK/NACK) messages.

23. A first user equipment (UE), comprising:
at least one memory;
at least one transceiver; and
at least one processor in communication with the at least one memory and the at least one transceiver, wherein the first UE is configured to:
compute a total physical sidelink feedback channel (PSFCH) transmit power for a quantity of PSFCH resource blocks (RBs), wherein the computing the total PSFCH transmit power for the quantity of PSFCH RBs comprises at least one of:
computing, when the first UE has received a PSFCH power requirement from a network device, the total PSFCH transmit power for the quantity of PSFCH RBs based on the PSFCH power requirement, the quantity of PSFCH RBs, a quantity of common interlace RBs, and a pathloss measurement between the first UE and the network device; or
computing, when the first UE has not received a PSFCH power requirement from the network device, the total PSFCH transmit power for the quantity of PSFCH RBs based on a maximum transmit power capability of the first UE, the quantity of PSFCH RBs, and the quantity of common interlace RBs; and
transmit a signal to a second UE including the PSFCH RBs at the total PSFCH transmit power.

24. The first UE of claim 23, wherein the first UE is further configured to:
compute a total common interlace transmit power based on the maximum transmit power capability, the quantity of PSFCH RBs, and the quantity of common interlace RBs,
wherein the transmitting the signal comprises transmitting the signal further including a common interlace at the total common interlace transmit power when the quantity of PSFCH RBs is below a predetermined value.

25. The first UE of claim 24, wherein the predetermined value is ten.

26. The first UE of claim 24, wherein the first UE is further configured to:
drop a subset of the PSFCH RBs when a sum of the total PSFCH transmit power and the total common interlace transmit power exceeds the maximum transmit power capability associated with the first UE.

27. The first UE of claim 26, wherein the first UE is further configured to drop the subset of the PSFCH RBs according to a priority order.

28. The first UE of claim 24, wherein the total PSFCH transmit power divided by the quantity of PSFCH RBs is equal to the total common interlace transmit power divided by the quantity of common interlace RBs.

29. The first UE of claim 23, wherein the first UE is further configured to:
receive the PSFCH power requirement from the network device.

30. The first UE of claim 23, wherein the PSFCH RBs carry one or more acknowledgement/negative acknowledgement (ACK/NACK) messages.
